(19) United States
(12) Patent Application Publication
(10) Pub. No.: US 2015/0312709 A1
(43) Pub. Date: Oct. 29, 2015

(54) Social and Entertainment Network based on Global Positioning and Statistics in Real Time

(71) Applicant: Eric Alexander Azcona Dominici, Bloomfield, NJ (US)

(72) Inventors: Eric Alexander Azcona Dominici, Bloomfield, NJ (US); Juan Jose Azcona Dominici, Bloomfield, NJ (US)

(21) Appl. No.: 14/263,712

(22) Filed: Apr. 28, 2014

(51) Int. Cl. H04W 4/02

(52) U.S. Cl. CPC H04W 4/02

(57) ABSTRACT

A novel social network is disclosed herein for providing dynamic feedback based on statistics and user preferences.

### CLAIM OF PRIORITY

This application claims priority to provisional application No. 61/432,225 filed on Jan. 13, 2011, the entirety of which is incorporated by reference herein.

### BACKGROUND/FIELD

The present invention relates generally to the field of entertainment and more specifically relates to a Social and Entertainment Network Based on Global Position and Statistics in Real time.

Many individuals in modern society seek entertainment. Entertainment consists of any activity which provides a diversion or permits people to amuse themselves in their leisure time. Entertainment is generally passive, such as watching opera or a movie. Active forms of amusement, such as recreations or sports, are more often considered to be recreation. Activities such as personal reading or practicing a musical instrument may be considered to be hobbies.

Entertainment may also provide a great deal of fun, enjoyment, laughter. Industries that provides entertainment are normally referred to as the entertainment industry. There are many forms of entertainment for example: cinema, theatre, sports, games and nightlife.

Nightlife is a collective term including virtually any entertainment that is available and more popular from the late evening into the early hours of the morning. It includes the public houses, nightclubs, discoth\check{e}ques, bars, live music, concert, cabaret, small theatres, small cinemas, shows, and sometimes restaurants a specific area may have; these venues often require cover charge for admission, and make their money on alcoholic and non-alcoholic beverages. Nightlife encompasses entertainment from the fairly tame to the risque to the seedy. Nightlife entertainment is inherently edgier than daytime amusements, and usually more oriented to adults, including “adult entertainment” in red-light districts. These forms of entertainment may be dangerous and expensive, a suitable alternative is desirable.

Various attempts have been made to solve problems found in entertainment art. Among these are found in: U.S. Pat. No. 7,788,188 to James Frederick Kramer; U.S. Pub. No. 2007/0214180 to C. S. Lee Crawford; U.S. Pub. No. 2006/0161599 to James S. Rosen and U.S. Pub. No. 7,593,740 to Dennis P. Crowley et al. This prior art is representative of entertaining means and modes.

None of the above inventions and patents, taken either singly or in combination, is seen to describe the invention as claimed. Thus, a need exists for a reliable and safe Social and Entertainment Network Based on Global Position and Statistics in Real time to facilitate the interaction between individuals in an efficient and effective manner and to avoid the above-mentioned problems.

### SUMMARY

According to certain embodiments of the present disclosure, a remote-access computer-implemented system for use by a user includes a host server having a plurality of databases configured therewithin; a plurality of users having smart-phones or portable electronic devices configured for remotely accessing the host server by means of a data network; and a plurality of venue records stored within the host server; wherein the host server databases contain information pertaining to each user selected from at least one of the following, demographic data, other users to whom they are acquainted, music and venue preferences of each user; wherein the host server databases pertaining to each venue contain at least one of the following, information of the location, user demographics, user population information, reviews, photographs, and videos; wherein upon query by the user, the host server responds with relevant aforementioned venue information and the user may choose to relocate to the displayed venue and have their information be added to the venue demographics or change their query criteria in which case the process is repeated.

According to further embodiments of the present disclosure, there is a global positioning receiver disposed within the cellular telephone or portable electronic device of the user operatively configured to collect location information and report said information to the remote server to provide location and demographic data.

According to further embodiments of the present disclosure, a user can send text, audio, photograph, or video messages other users within the system including for instance polling users who are already in attendance at a given venue, users who have similar interests, or users who they are acquainted with within the system.

According to further embodiments of the present disclosure, the remote server is operatively configured to collect and display statistical data about the users who patronize a given venue for review and analysis by businesses.

According to further embodiments of the present disclosure, the remote server is operatively configured to collect and record user statistics about the system at large, wherein the data collected are selected from at least one of the following, total population, population demographics relative to region, population demographics relative to a given venue, population demographics relative to a given interest, population demographics relative to frequency with which users patronize a given venue or type of activity.

According to further embodiments of the present disclosure, a user may query the remote server for desired venues based on venue criteria selected from at least one of the following, demographics of users present, population data of users present, feedback of users present, venue type, music type, food type, or presence of users to whom they are acquainted.

According to further embodiments of the present disclosure, the remote server includes that capability to suggest new users for a given user to become acquainted with based on at least one of the following, common interests, location, demographic data, geographic data.

According to further embodiments of the present disclosure, a user may choose to receive information from the system by not have their own information displayed within the total count or data for a given venue.

According to further embodiments of the present disclosure, the remote server can report to a business patron demographics and optionally offer patrons incentives and discounts based thereupon.

According to further embodiments of the present disclosure, a user may select whether they are automatically added to the list of users located at a given location based on the information collected from their electronic device from either network or GPS location services.

According to further embodiments of the present disclosure, a given user may organize his acquaintences into groupings based on at least one of the following, user-defined criteria, demographic information, useage data, or historical data.

According to further embodiments of the present disclosure, there is a business user type which affords a user the ability to edit, create, or modify information about a given venue or event within the system.

According to further embodiments of the present disclosure, the record for a given venue includes events, which are either one-time or recurring features at a given venue for which a business user can create at least one of the following, special information, pricing, photographs, target audience, mailings, or location.

According to further embodiments of the present disclosure, the record for a given venue include promotions, which are either one-time or recurring discounts or incentives chosen and distribute by one of the following, patronage statistics, demographic data, geographic data.

### BRIEF DESCRIPTION OF THE FIGURES

In the figures, which are not necessarily drawn to scale, like numerals describe substantially similar components throughout the several views. The drawings illustrate generally, by way of example, but not by way of limitation, various embodiments discussed in the claims of the present document.

FIG. 1 shows a perspective view illustrating a flowchart of the Social and Entertainment Network Based on Global Position and Statistics in Real time according to an embodiment of the present invention.

FIG. 2 is a perspective view illustrating another flowchart of the Social and Entertainment Network Based on Global Position and Statistics in Real time according to an embodiment of the present invention.

### DETAILED DESCRIPTION OF THE FIGURES

As discussed above, embodiments of the present invention relate to an entertainment means and more particularly to a Social and Entertainment Network Based on Global Position and Statistics in Real time as used to facilitate the interaction between individuals in an efficient and effective manner.

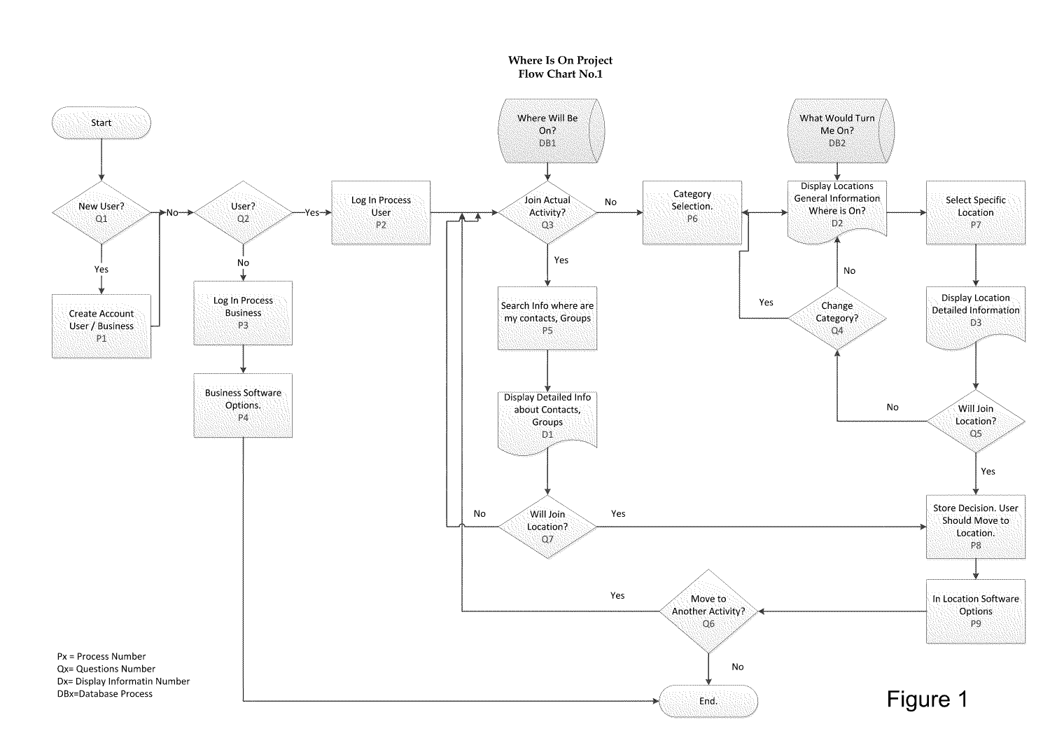

Referring now to the drawings FIG. 1, illustrating the Social and Entertainment Network Based on Global Position and Statistics in Real time and how it works via a process description as illustrated by the flowchart. Beginning with the start box (located on the upper left corner), the reader is able to trace the flow through the novel process embodied herein. Initially the user is prompted with a question where he/she indicates whether they are a new user or not—if yes than they are prompted to create a user account.

P1: Creating Account Business or User Account

A User account includes creating an account with the personal information of an individual. This display will contain basic information such as: First Name, Last name, e-mail address, gender, birthday, and phone number. Other information may be required upon user-preference.

P1-A: After the user creates the account, the user may have the option of personalizing their profile. This personalization preferably includes providing more personal information in the case the user prefers to share specific information such as: interested in, looking for, education, likes and interest and more complex information, everything divided by category.

### P1-A1: The Social Network Concept

At the time the user submits their profile information, the person may import their contacts or friends from other accounts such as: Facebook, Myspace, Google, Gmail, Hotmail, AOL. The application of this concept preferably allows the option to the user of join an actual group of friends or create different groups and establish different level of privacy for each group because the privacy is an element related to respect and is the responsibility of every individual within the present invention.

Privacy setting(s): the user is able to choose his/her preference between visible or invisible mode, selecting the options to share.

Visible mode: Option where the user can show personal information or can choose the information to share, between all users on the network or their group of friends. The user can select a nickname or use their personal information; the user can change the basic information on the mobile device and also on the pc, at the time of changing the information on the pc the user will have more detailed fields.

Invisible mode: Option wherein the user is just a number for the system and for their network. This invisible mode lets the system count the attendance but won't show the personal information to others users, the system will assigns a random number every time they select this option. The invisible option is available on the mobile device and also on the pc.

P1-B: Business Account

This account is designed for business(es), promoters and special events; these accounts contain fields such as: name of business, phone number, category, address, attendee's capacity and more information that could be accessed anytime. The venues may have a lot option on their page. These venues will handle statistics about how many people visited the venue along with advertising special events anytime the promoters prefer. This business account contains field like email address and password, permitting easy the access anytime a person with the business account wants to log on.

P1-B-1 Profile:

The owner of the venue may update the profile and they have the option of creating a picture gallery of the venue, sharing a video and showing a real time webcam. The profile will contain a field for feedback where the customers have the option to give a rate or feedback every time they visited the venue. This tool is ideal for the business in making improvements and to assess the surrounding market. Further, these tools will be helpful for the venue because the owners are able to see the attendance traffic in the business with the option of sorting the information by: date, event, category, and by age or gender of those who visited their place of business.

### P2: Login Process

This step is simple because after the account is created, the user will be asked for the username and password and will be directed to the main page. After the user enters the username and password, the user will find to the left all the information about their profile, on the middle the fields about the search they want to make display by category and to the right side the advertisements.

### P3: Login Process for Business

This login is different as compared to the user login because the business will be prompted by: business name and password and will be directed to a page with the profile of the venue without the search option how main factor.

### P4: Business Software Option

The Business software option permits a venue to publish their activities and what are they offering. This option will feed the database and will be the answer for the question “what would turn me on?” (DB2). This information will be updated by category, example: Ladies night all women free from 9:00 pm to 12:00 am. And the result will be displayed for the users when they perform a search by category and they choose “women”—like the factor that the user is interested in at that moment. Further, the Business software option allows the software to display that the user is on their way, so the person will know the quantity of people that will arrive, or if a specific location is having a party, the user can mark in the software that the user plans on attending thereby allowing other users to know that party “x” will be ON and held on a certain day. In this way an accurate count may be determined.

P5: Search Info where are My Contacts or Groups

The social network concept is integrated into this part of the process due to the user being asked if they want to join an actually party that is in process and where their friends are partying or to launch a search for a new activity.

### P6: Category Selection

This step of the process is where the user selects the search they want to launch such as: Venue Type: Adult, Afterwork, Irish Pub, Live Music, Lounge, Restaurant/Bar Event Type: Club DJ Happy Hour Live Music Outdoors/Patio Strip/Adult, Concerts, Boat/Cruise Music Type: Hip-Hop, Dance/Electronic, House, Pop, Latin, Rock. Another type of search is the search by preference or by a specific events, that was previously submitted by the venues (DB2). This step helps the user select and narrow his/her options to decide on an activity in which to engage in.

### P7: Select Specific Location

The user will select the venue of their preference from the result based on the search that they launched.

P8: Store Decision User should Move to Location

This step of the software is where the user preferably selects the decision of ‘join a party’, because previously in (DB1) the user activated the application and made the question of “Where Will Be on? And possibly selected a place from the group of friends or an event of their preference from the result of the category search. The user is counted the moment they arrive at the venue.

### P9: In Location Software Option

There will be a lot of options on the software. For example, before the users go to the venue, they can send a massive text messages to the attendees of the venue of their preference. For instance; if the venue is a restaurant, the users can ask questions about the restaurant or the quality of the food that is being served in real time. The users in the venue can respond to the message, or can be in ignored mode. The user may have the option to ask to the attendees how is the environment or can send a message to try to catch the perfect match.

Other options may include users being allowed to upload pictures or video or write on the “what happening” screen in real time thereby interacting with other users that are currently in the venue via chat. Before the users interact with other users, they will need to have permission for interaction between themselves and other users or the other users may block the request for protection of privacy. These options will be made possible thanks to the social network environment. The user can invite friend or write feedback about the place in real time. In this way the user is able to select his/her level of privacy and maintain a level of safety.

### Display

### D1: Display Detailed Info About Contacts Groups

Display #1 shows all the data info about the social networking environment, such as information about the personals groups previously created. This information is regarding all contacts that are joining activities in real time including for example Friends, Family, Business and others kind of groups.

D2: Display Locations General Information about where is on

The main screen of WIO is composed and based on the search launched by category. Display all the general information about the venues according the data input on the category selection example: “Lounge” having women ranging in age from 25-35 within a radius of 15 miles around the current location, the results will contain all the data based on the search criteria.

The information will be preferably sorted with the name of the place and the percentage to the right; the general info of how many women and men. This percentage will be calculated based on the capacity of the venue and the current attendees in real time. The venues will escalate position on the table based on the ratings and feedbacks written by the users and by the quantity of attendees.

### D3: Display Location Detailed Information

After the specific location is selected from the main screen, the user will be redirected to the business profile. The user will find everything of important detail about the venue.

Questions Process: the present software presents the following questions to navigate the user through the process:

Q1: New user?
New user or registered?
Registered: will pass to the login process and run the software
New user: Start with the signup process

### Q2: User?

User Login: Login for regular user
Business Login: Login for business will be redirected to the business software option
Q3: Join actual activity?
Choose between join a current activity or launch a search for a new activity.
Q4: Change category?

Based on the answer of Q5 will join the location the software ask for a category change. If the user answers negative, the user will then proceed to change the category, but if the answer to Q5 is positive the user will join the location and enjoy all the features that the software offers.

### Q5: Will Join the Location?

Question after seeing all the detailed information of a location, if the answer is positive the user will proceed to the location and will enjoy all of the features, but if the answer is negative, the user will proceed to other question and have the option of changing the category.

### Q6: Move to Another Activity?

Question after the user has joined a location, to know if the user wants to finish with the software or wants to go to another activity.

### Q7: Will Join the Activity?

Question regarding if the user will join and activity from their groups or will start a new search by category.

DB1: Where Will be on? (Located Top Center)

The option based on a plan made by the user, where the user previously selected the venue and this venue previously upload the info. This option will work like a guest list uploaded by the business.

DB2: What would Turn Me on? (Located Top Right)

Question based on the specific activities previously uploaded by the business. This includes special events or some preference.

In these ways and potentially other suitable equivalent ways the present invention prompts and directs a user based on the inputs to join activities according to user-preference. The reader is encouraged to trace the flowchart through the various steps/prompts for a full understanding of the process.

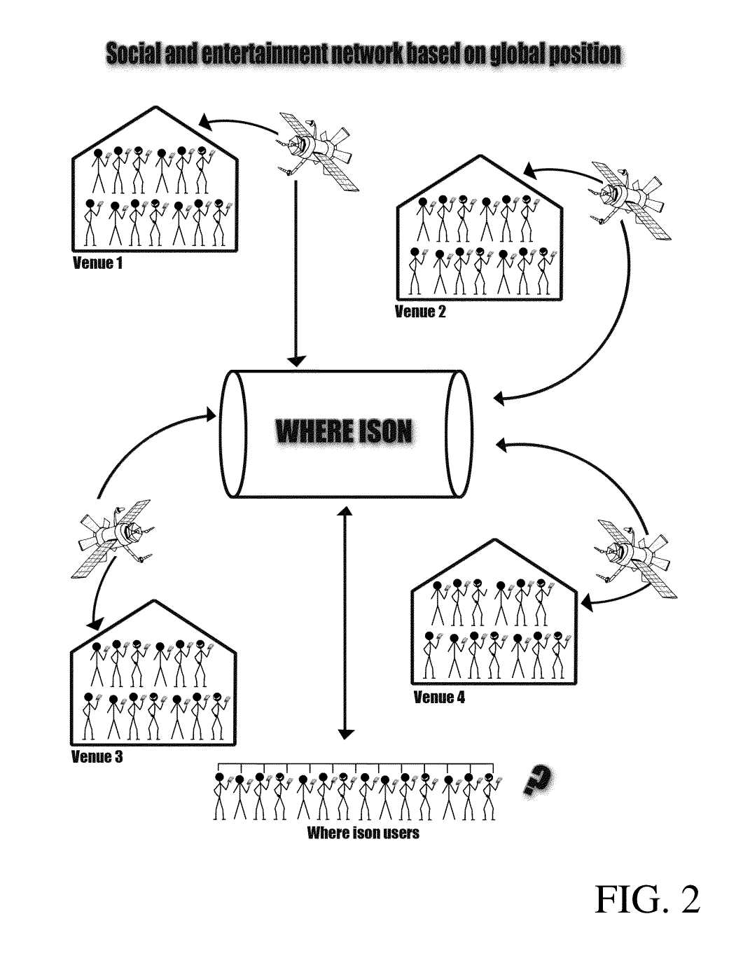

Referring now to FIG. 2, illustrating Social and Entertainment Network Based on Global Position, the flowchart showing Venues 1-4, global positioning satellites, where ison and where ison users are in relation to each other using the following enabling explanation.

### The Novelties

The novelties on this application comprise managing the statistics in real time. With the Social and Entertainment Network Based on Global Position on the user's mobile phone, once a registered user gets into a registered place, the user's attendance is counted offering the information to other users. This counting is made possible vai GPS capabilities of the mobile devices, and the GPS coordinate of the location. If another user get into the same place that user will be counted also, and the attendance statistic will increase one user at a time.

### Flowchart #2 Process Description

### Example #1

The venue #1 is a place (location) registered with:

Latitude: 38.2659624 and Longitude: −85.6230843

The users has GPS tracking turned to an on position on their mobile device. When the user gets into the Latitude and Longitude of the venue, the mobile device will send the coordinates of the user's position to the WHEREISON database, making the information available to other users.

### Example #2

The venue #1 has 13 users and these users are divided on 7 women and 6 men

The venue #2 has 11 users and these users are divided on 5 women and 6 men

The venue #3 has 10 users and these users are divided on 7 women and 3 men

The venue #4 has 7 users and these users are divided on 3 women and 4 men

All of them are registered users and all the venues are registered venues. The information of the four venues will be displayed on a page when other users launch a search based on the current position of the user(s).

The table will preferably show the following information:

| Venue | Capacity | Total | Women | Men | % |
|---|---|---|---|---|---|
| Venue #1 | 20 | 13 | 7 | 6 | 65% |
| Venue #2 | 25 | 11 | 5 | 6 | 44% |
| Venue #3 | 26 | 10 | 7 | 3 | 38% |
| Venue #4 | 23 | 7 | 3 | 4 | 30% |

The information above is the general information shown when a user launches a typical search based on the category and the current location. The interaction of the user and WHEREISON is always in real time, the information flows in both directions from and to, all the interaction flows through the satellite and the mobile networks as indicated by flow arrows. (The information in detail about the software operation is available on the flowchart #1).

The present invention in the above described ways provides the Social and Entertainment Network Based on Global Position and Statistics in Real time as used to facilitate the interaction between individuals in an safe, efficient and effective manner using the technology described herein. It should also be appreciated that future technologies may be held within the scope of the invention provided they perform an equivalent functionality.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A remote-access computer-implemented system for use by a user comprising;
a host server having a plurality of databases configured therewithin; a plurality of users having smart-phones or portable electronic devices configured for remotely accessing the host server by means of a data network; and a plurality of venue records stored within the host server; wherein the host server databases contain information pertaining to each user selected from at least one of the following, demographic data, other users to whom they are acquainted, music and venue preferences of each user; wherein the host server databases pertaining to each venue contain at least one of the following, information of the location, user demographics, user population information, reviews, photographs, and videos; wherein upon query by the user, the host server responds with relevant aforementioned venue information and the user may choose to relocate to the displayed venue and have their information be added to the venue demographics or change their query criteria in which case the process is repeated.

2. The system of claim 1, wherein there is a global positioning receiver disposed within the cellular telephone or portable electronic device of the user operatively configured to collect location information and report said information to the remote server to provide location and demographic data.

3. The system of claim 1, wherein a user can send text, audio, photograph, or video messages other users within the system including for instance polling users who are already in attendance at a given venue, users who have similar interests, or users who they are acquainted with within the system.

4. The system of claim 1, wherein the remote server is operatively configured to collect and display statistical data about the users who patronize a given venue for review and analysis by businesses.

5. The system of claim 1, wherein the remote server is operatively configured to collect and record user statistics about the system at large, wherein the data collected are selected from at least one of the following, total population, population demographics relative to region, population demographics relative to a given venue, population demographics relative to a given interest, population demographics relative to frequency with which users patronize a given venue or type of activity.

6. The system of claim 1, wherein a user may query the remote server for desired venues based on venue criteria selected from at least one of the following, demographics of users present, population data of users present, feedback of users present, venue type, music type, food type, or presence of users to whom they are acquainted.

7. The system of claim 1, wherein the remote server includes that capability to suggest new users for a given user to become acquainted with based on at least one of the following, common interests, location, demographic data, geographic data.

8. The system of claim 1, wherein a user may choose to receive information from the system by not have their own information displayed within the total count or data for a given venue.

9. The system of claim 1, wherein the remote server can report to a business patron demographics and optionally offer patrons incentives and discounts based thereupon.

10. The system of claim 1, wherein a user may select whether they are automatically added to the list of users located at a given location based on the information collected from their electronic device from either network or GPS location services.

11. The system of claim 1, wherein a given user may organize his acquaintences into groupings based on at least one of the following, user-defined criteria, demographic information, useage data, or historical data.

12. The system of claim 1, wherein there is a business user type which affords a user the ability to edit, create, or modify information about a given venue or event within the system.

13. The system of claim 12, wherein the record for a given venue includes events, which are either one-time or recurring features at a given venue for which a business user can create at least one of the following, special information, pricing, photographs, target audience, mailings, or location.

14. The system of claim 12, wherein the record for a given venue include promotions, which are either one-time or recurring discounts or incentives chosen and distribute by one of the following, patronage statistics, demographic data, geographic data.

15. A remote-access computer-implemented system for use by a user comprising;
a host server having a plurality of databases configured therewithin; a plurality of users having smart-phones or portable electronic devices configured for remotely accessing the host server by means of a data network; and a plurality of venue records stored within the host server; wherein the host server databases contain information pertaining to each user selected from at least one of the following, demographic data, other users to whom they are acquainted, music and venue preferences of each user; wherein the host server databases pertaining to each venue contain at least one of the following, information of the location, user demographics, user population information, reviews, photographs, and videos; wherein upon query by the user, the host server responds with relevant aforementioned venue information and the user may choose to relocate to the displayed venue and have their information be added to the venue demographics or change their query criteria in which case the process is repeated; wherein the remote server is operatively configured to collect and display statistical data about the users who patronize a given venue for review and analysis by businesses; wherein the remote server is operatively configured to collect and record user statistics about the system at large, wherein the data collected are selected from at least one of the following, total population, population demographics relative to region, population demographics relative to a given venue, population demographics relative to a given interest, population demographics relative to frequency with which users patronize a given venue or type of activity.

16. A remote-access computer-implemented system for use by a user comprising;
a host server having a plurality of databases configured therewithin; a plurality of users having smart-phones or portable electronic devices configured for remotely accessing the host server by means of a data network; and a plurality of venue records stored within the host server; wherein the host server databases contain information pertaining to each user selected from at least one of the following, demographic data, other users to whom they are acquainted, music and venue preferences of each user; wherein the host server databases pertaining to each venue contain at least one of the following, information of the location, user demographics, user population information, reviews, photographs, and videos; wherein upon query by the user, the host server responds with relevant aforementioned venue information and the user may choose to relocate to the displayed venue and have their information be added to the venue demographics or change their query criteria in which case the process is repeated; wherein a user can send text, audio, photograph, or video messages other users within the system including for instance polling users who are already in attendance at a given venue, users who have similar interests, or users who they are acquainted with within the system; wherein a user may choose to receive information from the system by not have their own information displayed within the total count or data for a given venue.
